(19) United States
(12) Patent Application Publication
(10) Pub. No.: US 2005/0286194 A1
(43) Pub. Date: Dec. 29, 2005

(54) Power transistor device and a power control system for using it

(76) Inventors: Atsushi Fujiki, Maebashi (JP); Masatoshi Nakasu, Shibukawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/111,749

(22) Filed: Apr. 22, 2005

(30) Foreign Application Priority Data
Jun. 23, 2004 (JP) 2004-184792

(51) Int. Cl. H02H 3/00

(52) U.S. Cl. 361/100

(57) ABSTRACT

The object of the invention is to protect a power MOS transistor using a transistor having trench structure from overcurrent and to enhance the reliability. To achieve the object, a power MOS transistor, a transistor for detecting current for detecting the current of the power MOS transistor and generating a detection signal supplied to an external control circuit and devices configuring a protection circuit for detecting the current of the power MOS transistor and inhibiting current by forcedly dropping the gate voltage of the power MOS transistor when current equal to or exceeding a predetermined value flows are provided in the same semiconductor chip.

### CROSS-REFERENCE TO RELATED APPLICATION

The present application claims priority from Japanese patent application No. 2004-184792 filed on Jun. 23, 2004, the contents of which are hereby incorporated by reference into this application.

### BACKGROUND OF THE INVENTION

The present invention relates to effective technique in applying to a power transistor that makes heavy-current flow and further, a power transistor device configured by a semiconductor integrated circuit, particularly relates to effective technique in utilizing for power MOS transistor IC the ON-state resistance of which is small and which is provided with an overcurrent protection function.

Relatively heavy-current is made to flow in an electrical part such as a lamp of an automobile, a coil of a regulator and others. Heretofore, a semiconductor device called a power transistor has been used for a device for making current flow in a load requiring heavy-current. Such a power transistor has two types of a type using a bipolar transistor and a type using MOSFET, however, recently, a power MOS transistor using MOSFET has been used relatively much.

As overcurrent flows in a power transistor when a load or wiring over which current flows from the power transistor is short-circuited and the power transistor itself may be broken, various overcurrent protection technique for protecting the power transistor from overcurrent is heretofore proposed. In prior general overcurrent protection technique, current flowing in a power transistor is detected, is fed back to a control circuit, and in case detected current exceeds a predetermined value, the power transistor is turned off by the control circuit.

[Patent document 1] Japanese Unexamined Patent Publication No. 2003-174098

### SUMMARY OF THE INVENTION

As heavy-current flows into a power MOS transistor, it is important so as to reduce loss in the transistor to reduce the ON-state resistance. Then, these inventors discussed a power transistor in which the length of a channel for distance between a source and a drain was relatively extended so as to reduce the ON-state resistance by configuring structure (hereinafter called trench structure) where a groove was made over a semiconductor substrate and a gate electrode made of polysilicon or others was formed by filling it in the groove in the vertical type power MOS transistor provided with a source electrode on one side and a drain electrode on the other side.

As a result, the transistor having trench structure can realize lower ON-state resistance, compared with a transistor having normal planar structure, however, the transistor having trench structure has a tendency that as the mutual conductance (gm) is large and the saturated drain current is also much, the breaking strength in an abnormality such as the earth fault of power supply decreases. Generally, for protection from such an abnormality, overcurrent is detected, is fed back to a control circuit, and a power transistor is turned off, however, the delay of a response equal to or exceeding 100 μs (microsecond) occurs. In a power transistor having normal planar structure, as shown by an alternate long and short dash line A1 in FIG. 2A, at time elapsed by the delay of a response Trd since overcurrent occurs T0, the power transistor is turned off according to a signal from a control circuit and current flowing into the power transistor is cut off.

However, it is clarified that as the mean current density is high in the transistor having trench structure, operation for protection is not in time as shown by a full line B1 in FIG. 2A and the transistor may be broken. A method of accelerating the speed of a response by providing a control circuit for controlling a power transistor in the same semiconductor chip as the power transistor is conceivable, however, as a result, a problem that the size of the chip is extended and the cost of the chip is increased occurs.

Particularly, as coupling between devices is difficult when a vertical type transistor is also used for a transistor for configuring the control circuit in case the power transistor has trench structure, a transistor of a horizontal type is required to be used. However, as desired characteristics cannot be acquired when the MOS transistor of a horizontal type is formed in a process for the vertical type transistor, a problem that the number of processes is required to be increased and thereby, the cost of the chip is further increased occurs.

For the invention related to overcurrent protection technique for protecting a power transistor from overcurrent, there is the invention disclosed in the patent document 1 for example. In the prior invention, separately from a control circuit for turning off a power transistor in case current flowing into the power transistor is detected and detected current exceeds a predetermined value, a protection circuit for inhibiting current by forcedly dropping the gate voltage of the power transistor when current equal to or exceeding a predetermined value flows is provided to the same semiconductor chip as the power transistor. However, the power transistor in the prior invention is not a transistor having trench structure. Therefore, the density of drain current is not high, compared with that in a power transistor using a transistor having trench structure and the necessity of the protection circuit is low.

The object of the invention is to provide technique for protecting from overcurrent a power MOS transistor using a transistor having trench structure and enabling the enhancement of the reliability.

Another object of the invention is to provide the overcurrent protection technique of a power MOS transistor excellent in a response characteristic until the current of the power transistor is reduced since overcurrent is detected for enabling minimizing the extension of chip size and the increase of the cost.

The above-mentioned and other objects and new characteristics of the invention will be clarified from the description of this specification and attached drawings.

The summary of a representative of the invention disclosed in this publication is as follows.

That is, in a power MOS transistor device using a transistor having trench structure, a power MOS transistor, a transistor for detecting current which detects the current of the power MOS transistor to generate a detection signal supplied to an external control circuit, and a device configuring a protection circuit for inhibiting current by forcedly dropping the gate voltage of the power MOS transistor when the current of the power MOS transistor is detected and current equal to or exceeding a predetermined value flows are provided in the same semiconductor chip.

According to the above-mentioned means, as the current of the power MOS transistor is inhibited by the built-in protection circuit before the current of the power MOS transistor is cut off by the external control circuit when current equal to or exceeding a predetermined value flows in the power MOS transistor, the destruction of the power MOS transistor can be avoided even if overcurrent flows into the power MOS transistor by the short-circuit of a load or others.

The power MOS transistor having trench structure is a vertical type MOS transistor in which drain current flows in a direction of the thickness of a semiconductor chip, plural minute transistors are arranged, and a source electrode and a drain electrode are coupled in common. The transistor for detecting current is a power MOS transistor having the same trench structure as the power MOS transistor and a transistor configuring the protection circuit is a MOS transistor of a horizontal type in which drain current flows in a horizontal direction of the semiconductor chip. Further, the pitch of the gate electrodes of plural minute transistors configuring the power MOS transistor shall be 5 μm or less. As the density of drain current is increased to an extent that cutoff control over the current of the power MOS transistor by the external control circuit is not in time in case the pitch of the gate electrodes is 5 μm or less, necessity for providing the protection circuit in the same semiconductor chip increases and the invention becomes effective.

The brief description of effect acquired by the representative of the invention disclosed in this publication is as follows.

That is, according to the invention, the power MOS transistor using a transistor having trench structure is protected from overcurrent and the reliability can be enhanced.

### BRIEF DESCRIPTION OF THE DRAWINGS

FIG. 1 is a circuit diagram showing an embodiment of a power MOS transistor device according to the invention and a power control system to which the transistor device is applied;

FIG. 2A shows the waveform of current showing the variation of current in a power transistor device when a load is short-circuited in a power control system to which the power MOS transistor device discussed prior to the invention is applied, and FIG. 2B shows the waveform of current showing the variation of current in the power transistor device when a load is short-circuited in the power control system to which the power MOS transistor device according to the invention is applied;

FIG. 3 is a plan showing an example of the layout of power IC equivalent to the embodiment;

FIG. 4 is a sectional view showing the structure of a vertical type transistor used for a power MOS transistor in the embodiment;

FIG. 5 is a sectional view showing the structure of a transistor of a horizontal type, a resistor and a diode used for a transistor for protection configuring an overcurrent protection circuit in the power IC equivalent to the embodiment; and

FIGS. 6A and 6B are plans showing examples of the planar structure of a gate electrode of the power MOS transistor in the embodiment.

### DETAILED DESCRIPTION OF THE PREFERRED EMBODIMENT

Referring to the drawings, a preferred embodiment of the invention will be described below.

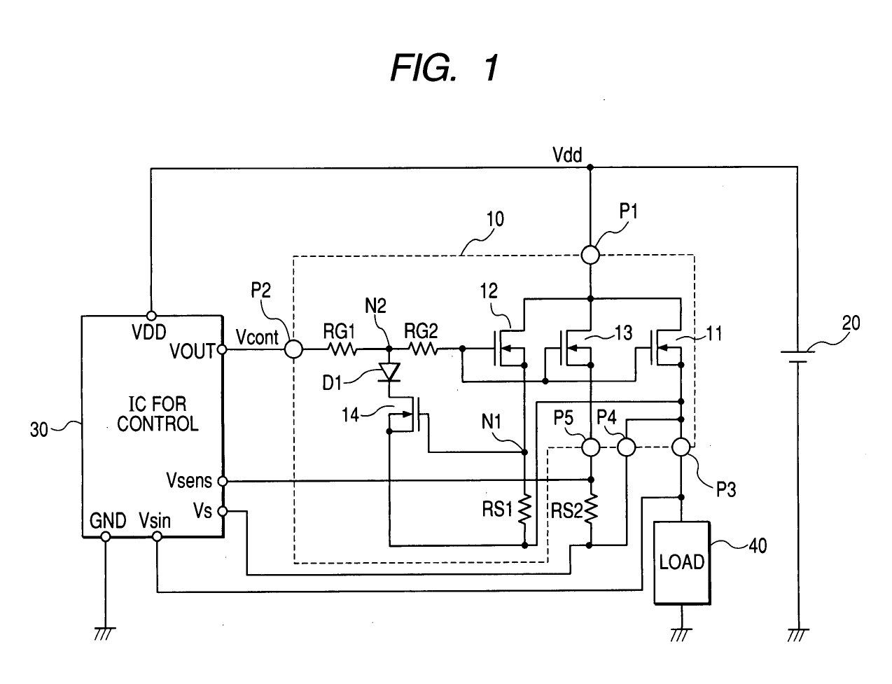

FIG. 1 shows an embodiment of a power MOS transistor device according to the invention and a power control system to which the power MOS transistor device is applied. Though it is not particularly limited, each device provided in a part encircled by a broken line 10 is formed in one semiconductor chip made of monocrystalline silicon as a semiconductor integrated circuit by a well-known MOS manufacturing process. In this specification, a semiconductor integrated circuit 10 including a power MOS transistor is called power IC.

The power IC 10 equivalent to this embodiment includes: a power MOS transistor 11 in which a drain terminal is coupled to a power supply voltage terminal P1 to which power supply voltage Vdd supplied from a direct voltage source 20 such as a battery is applied, and control voltage Vcont from IC for control 30 is applied to the gate terminal; and transistors for detecting current 12, 13 in which each drain terminal is coupled to the power supply voltage terminal P1 and control voltage Vcont from the IC for control 30 is applied to each gate terminal like the power MOS transistor 11. Drain current acquired by reducing the drain current of the power MOS transistor 11 in proportion to the size of the devices by setting the size (the area of each source region) of the transistors to one a few 100th to one a few 1000th of the size (the area of a source region) of the power MOS transistor 11 is made to flow to the transistors for detecting current 12, 13.

A resistor RS1 coupled between a source terminal of the transistor for detecting current 13 and a source terminal of the power MOS transistor 11, a transistor for protection 14 in which the electric potential of a node N1 between the source terminal of the transistor for detecting current 13 and the resistor RS1 is applied to a gate terminal, and resistors RG1, RG2 coupled in series between an external input terminal P2 to which control voltage Vcont from the IC for control 30 is applied and a gate terminal of the transistor for detecting current 13 are provided to the power IC 10. A drain terminal of the transistor for protection 14 is coupled to a node N2 between the resistors RG1 and RG2 and a source terminal of the transistor for protection 14 is coupled to the source terminal of the power MOS transistor 11.

The reason why the resistor RG2 is provided is to prevent the gate voltage of the transistor for detecting current 12 from rapidly dropping the moment that the transistor for protection 14 is turned on and to prevent wrong detected voltage from being input to a detection input terminal Vsens of the IC for control 30. A diode for preventing a backflow D1 is coupled between the transistor for protection 14 and the gate terminal of the transistor for detecting current 13. The diode D1 is provided with action for preventing current from flowing from the control input terminal P2 to the IC for control 30 via a parasitic diode Db existing in the substrate of the transistor 14 when voltage higher than power supply voltage Vdd is applied to an output terminal P3 and preventing the IC for control 30 from being broken.

Further, in the power IC 10 equivalent to this embodiment, an external terminal P4 to which the source terminal of the power MOS transistor 11 is coupled separately from the output terminal P3 for making driving current flow in a load 40, and an external terminal P5 to which the source terminal of the transistor for detecting current 13 is coupled are provided. A resistor for sensing RS2 is coupled outside the chip between these external terminals P4 and PS, the electric potential at both ends of the resistor for sensing RS2 is input to detection input terminals Vsens, Vs of the IC for control 30, and the IC for control 30 can detect overcurrent flowing in the power MOS transistor 11.

Separately from the above-mentioned, the electric potential of the output terminal P3 to which the source terminal of the power MOS transistor 11 is coupled is input to a detection input terminal Vsin of the IC for control 30. The IC for control 30 generates control voltage Vcont to be applied to the gate of the power MOS transistor 11 so that driving current flowing from the power MOS transistor 11 to the load 40 based upon the input potential is predetermined current.

The reason why the source terminal of the power MOS transistor 11 is coupled to the two terminals (P3, P4) is that impedance from the source terminal of the power MOS transistor 11 to the external terminal P3 and impedance from the source terminal of the power MOS transistor to the external terminal P4 are different depending upon wiring and bonding wire, and as heavy-current flows to the external terminal P3 to which the load is coupled if electric potential input to the IC for control 30 is extracted from the external terminal P3, electric potential is considerably set off depending upon the slight difference of impedance.

In the power IC 10 equivalent to this embodiment, as the transistor for detecting current 13 is provided separately from the transistor for detecting current 12, the electric potential of the output terminal P3 drops because of the short-circuit of the load when the load 40 or wiring such as a wire harness is short-circuited and overcurrent flows into the power MOS transistor 11 for example, source voltage between the transistors 11 and 13 is differed, and current flows from the transistor 13 via the resistor for sensing RS1. When the current exceeds a predetermined value, voltage between the terminals of the resistor for sensing RS1, that is, a voltage drop by resistance is equal to or exceeds the threshold voltage of the transistor for protection 14, the transistor 14 is turned on, the gate voltage of the transistors 11 to 13 is lowered, and current flowing into the power MOS transistor 11 is reduced.

In the meantime, when the electric potential of the output terminal P3 drops because of the short-circuit of the load or the wiring, current also flows into the resistor for sensing RS2, is converted to voltage in the resistor RS2, and is input to the IC for control 30. As a result, the IC for control 30 determines that overcurrent flows in the power MOS transistor 11 and functions so that control voltage Vcont is dropped and current flowing in the power MOS transistor 11 decreases. When the response time Tr1 of the transistor for protection 14 and the response time Tr2 of the IC for control 30 at this time are compared, the response time Tr1 of the transistor for protection 14 is shorter because the transistor for protection 14 is a device formed in the same chip as the power MOS transistor 11.

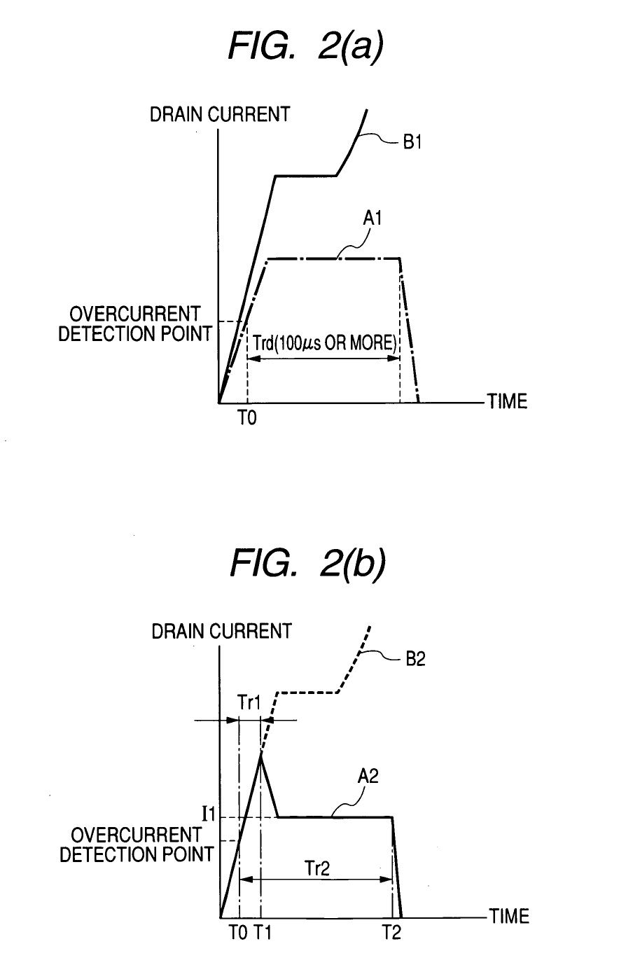

Therefore, as shown in FIG. 2B, when the transistor for protection 14 is turned on at the time T1 after the elapse of Tr1 since overcurrent is caused (T0), the gate voltage of the transistors 11 to 13 is lowered and current flowing into the power MOS transistor 11 is reduced up to predetermined current I1 as shown by a full line A2. At the time T2 after the elapse of Tr2 since T0, current flowing into the power MOS transistor 11 is cut off by control voltage Vcont from the IC for control 30. As a result, as shown by a broken line B2 in FIG. 2B, the power MOS transistor can be prevented from being broken due to flow of overcurrent into the power MOS transistor 11.

Next, the structure of the power IC 10 equivalent to this embodiment will be described.

In the power IC 10 equivalent to this embodiment, the power MOS transistor 11 and the transistors for detecting current 12 and 13 are configured by a transistor having trench structure in which a groove is made over the semiconductor substrate and a gate electrode made of polysilicon or others is formed by filling it in the groove and in the meantime, the transistor for protection 14 is configured by a transistor of a horizontal type, that is, having planar structure.

The relative length of a channel for distance between the source and the drain is extended and the ON-state resistance can be reduced by configuring the power MOS transistor 11 by the transistor having trench structure. The precise ratio of current can be acquired by configuring the transistors for detecting current 12 and 13 by the transistor having the same trench structure as that of the power MOS transistor 11.

The reason why the transistor for protection 14 is configured by the transistor of a horizontal type, that is, having planar structure is that wiring for coupling an electrode on the side of the surface of the substrate and an electrode on the other side is required and the structure is difficult when the transistor having trench structure is used although the source terminal of the transistor for protection 14 is required to be coupled to the source terminal of the power MOS transistor 11, the gate terminal of the transistor for protection is required to be coupled to the source terminal of the transistor for detecting current 12 and further, the drain terminal of the transistor for protection is required to be coupled to the gate terminal of the transistor for detecting current 13 as clear referring to the circuit diagram shown in FIG. 1.

Further, in the power IC 10 equivalent to this embodiment, the power MOS transistor 11 has structure (hereinafter called cell structure) that plural minute transistors are arranged and a source electrode and a drain electrode are formed in common coupling or so that they continue. In case the power MOS transistor 11 is configured by a transistor having structure provided with a source region and a drain region made of a continuous diffused layer, the transistor becomes a transistor the mean current density of which is small and the total current quantity of which is small because current flows in a biased state, however, a transistor the mean current density of which is increased and the total current quantity of which is much can be acquired by using cell structure.

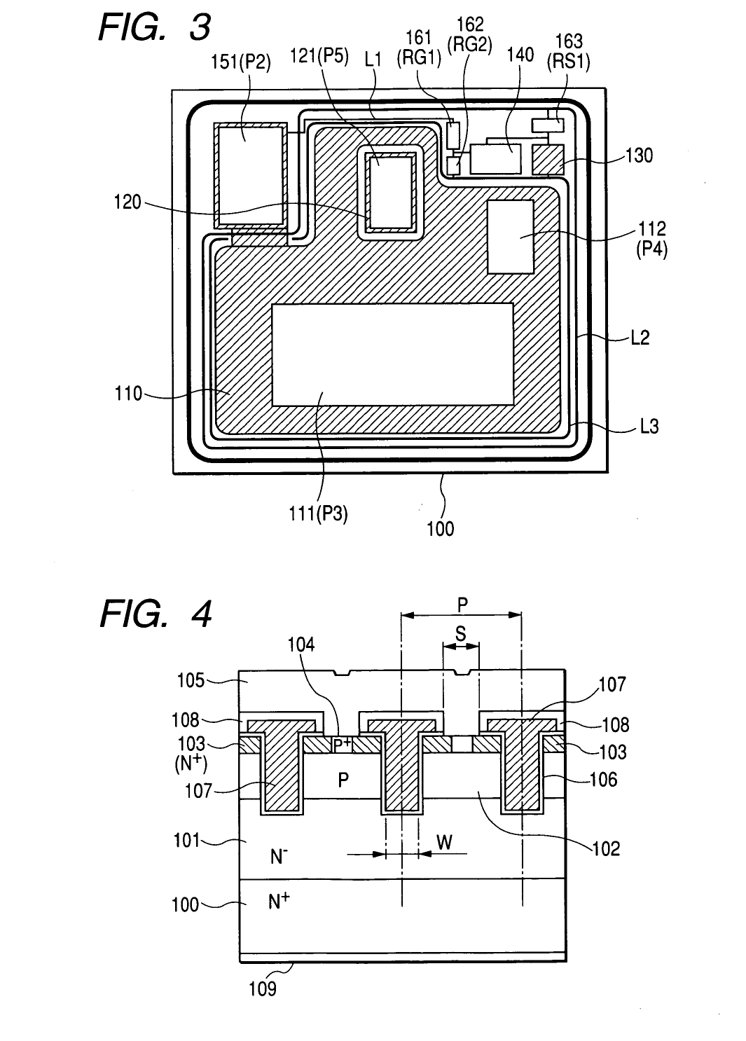

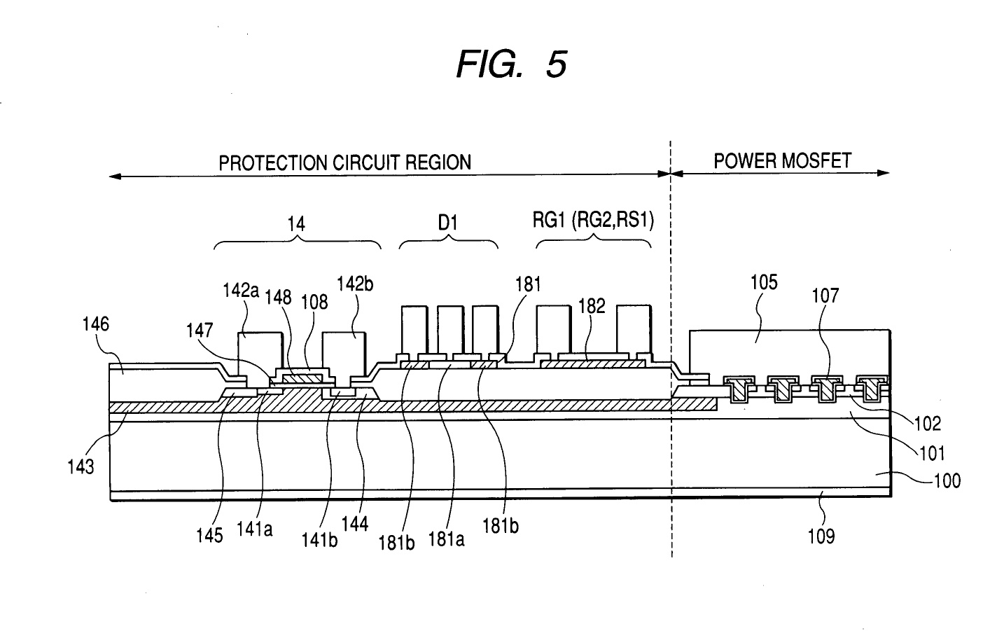

FIG. 3 shows the layout of the power IC 10 equivalent to this embodiment. FIG. 4 shows the structure of a transistor having trench structure to which cell structure used for the power MOS transistor 11 is applied and FIG. 5 shows the structure of a transistor of a horizontal type, that is, having planar structure used for the transistor for protection 14.

As shown in FIG. 3, a reference number 100 denotes a semiconductor chip made of monocrystalline silicon, a hatched region 110 in the center of this chip is a region in which a diffused layer to be the source region of the power MOS transistor 11 and the gate electrode are formed. A white rectangular region 111 substantially in the center of the hatched region 110 denotes a pad equivalent to the output terminal P3 shown in FIG. 1 coupled to the source of the power MOS transistor 11, a white rectangular region 112 in the similarly hatched region 110 denotes a pad equivalent to the terminal P4 shown in FIG. 1 coupled to the source terminal of the power MOS transistor 11, a rectangular region 120 in the hatched region 110 denotes a region in which a diffused layer to be the source region of the transistor for detecting current 12 and the gate electrode are formed, and 121 denotes a pad equivalent to the terminal P5 shown in FIG. 1 coupled to the source terminal of the transistor 12.

Further, a white rectangular region 151 on the upper left side denotes a pad equivalent to the input terminal P2 shown in FIG. 1 to which control voltage Vcont applied to the gate terminals of the transistors 11 to 13 is input, a hatched rectangular region 130 on the upper right side denotes a region in which a diffused layer to be the source region of the transistor 13 and the gate electrode are formed, an adjacent rectangular region 140 is a region in which a diffused layer to be the source region and the drain region of the transistor 14 of a horizontal type and the gate electrode are formed, and 161, 162 and 163 denote regions in which the resistors RG1, RG2, RS1 shown in FIG. 1 are respectively formed. “L1” denotes an image showing wiring for coupling the pad 151 equivalent to the input terminal P2 of control voltage Vcont and the resistor RG1, L2 denotes an image showing wiring of low impedance for coupling the resistor RS1 and the source of the power MOS transistor 11, and L3 denotes an image showing wiring for coupling the gate terminals of the transistors 11 to 13.

In FIG. 4, the structure of the transistor having trench structure to which cell structure used for the power MOS transistor 11 in this embodiment is applied is shown.

As shown in FIG. 4, a reference number 101 denotes a low-density N-type epitaxial layer formed oh the surface of the high-density N-type semiconductor substrate 100 made of a semiconductor such as monocrystalline silicon, 102 denotes a P-type diffused layer to be a channel layer of FET formed on the surface of the N-type epitaxial layer 101, and a high-density N-type diffused layer 103 to be a source region of FET is formed on the surface of the P-type diffused layer 102. Besides, a high-density P-type diffused layer 104 is formed in a part of the high-density N-type diffused layer 103 to reduce contact resistance with a source electrode 105 made of a conductor such as aluminum.

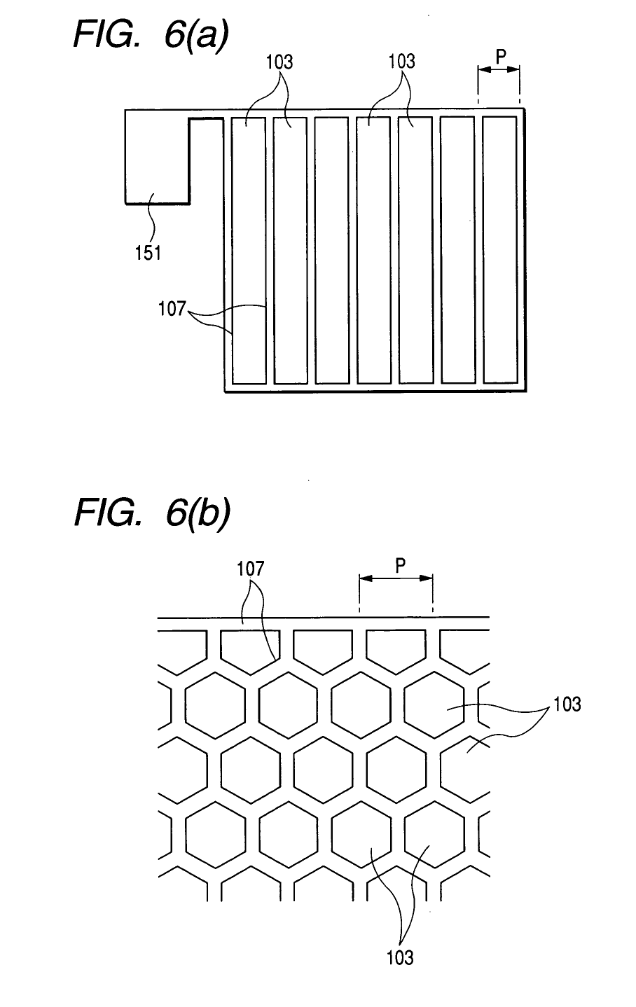

Further, a U-shaped groove is made to pierce the P-type diffused layer 102 as the channel layer and to reach the epitaxial layer 101, a thin gate oxide film 106 is formed inside the U-shaped groove by thermal oxidation, polysilicon is filled inside the gate oxide film, and a gate electrode 107 patterned in a predetermined shape is formed. In FIG. 4, three gate electrodes 107 mutually isolated are shown, however, these gate electrodes are formed so that they continue in a part not shown. Concretely, when the gate electrode 107 is viewed from the top, it is formed in a stripe shown in FIG. 6A or in a honeycomb type shown in FIG. 6B. The shape of the gate electrode 107 is not limited to these and may be also like the teeth of a comb or like a grid orthogonal vertically and horizontally.

An insulating film 108 such as a silicon nitride film is formed on the surface of the gate electrode 107 and electrically isolates the gate electrode from the source electrode 105. The semiconductor substrate 100 is used for a drain region and a conductive layer 109 to be a drain electrode is formed on the back throughout.

In the power IC equivalent to this embodiment, the pitch P of the gate electrode 107 is designed so that it is approximately 5 μm or less. The width W of the gate electrode 107 in the U-shaped groove is designed so that it is 0.3 to 1 μm and distance between adjacent gate electrodes 107, that is, a gap S is designed so that it is 1 μm or more.

In FIG. 5, each structure of the transistor of a horizontal type or having planar structure used for the transistor for protection 14 configuring an overcurrent protection circuit in the power IC equivalent to this embodiment, the resistors and the diode is shown. These devices are simultaneously formed utilizing a process for forming a semiconductor region and an electrode configuring the power MOS transistor having trench structure shown in FIG. 4. Then, in FIG. 5, the power MOS transistor having trench structure is also shown.

In FIG. 5, reference numbers 141a, 141b denote high-density N-type diffused layers to be the source region and the drain region of the transistor for protection 14, 142a and 142b denote a source electrode and a drain electrode formed by conductive material such as aluminum, the diffused layers 141a, 141b are simultaneously formed in the same process as the high-density N-type diffused layer 103 to be the source region of the power MOS transistor, and the source electrode and the drain electrode 142a, 142b are simultaneously formed in the same process as the source electrode 105 of the power MOS transistor. The diffused layer 141b to be the drain region out of the diffused layers 141a, 141b is directly formed on the surface of a P-type well layer 143 to be the channel layer formed in a part of the N-type epitaxial layer 101, the diffused layer 141a to be the source region is formed on the surface of the P-type well layer 143, and they are formed in a part of a low-density N-type diffused layer 144.

A high-density P-type diffused layer 145 for reducing contact resistance is formed in contact with the diffused layer 141a to be the source region and a relatively thick field oxide film 146 is formed around the source region and the drain region of the transistor for protection 14. A gate electrode 148 made of a polysilicon layer is formed via a gate oxide film 147 between the diffused layers 141a, 141b and the insulating film 108 is formed on the gate electrode 148.

A polysilicon layer 181 to be the diode D1 and a polysilicon layer 182 to be the resistor RG1, RG2 or RS1 are formed over the field oxide film 145. An anode region 181a into which impurities to be an acceptor are doped is formed in the center of the polysilicon layer 181 of these, a cathode region 181b into which impurities to be a donor are doped is formed on both sides of it, and a PN junction diode is configured. In FIG. 5, the cathode region 181b is divided in two, however, the cathode region is formed when it is viewed from the top so that it surrounds the anode region 181a and they are made at the same electric potential.

The polysilicon layers 181 and 182 are simultaneously formed in the same process as a polysilicon layer to be the gate electrode 148 of the transistor for protection 14. P-type impurities are doped into the polysilicon layer 182 throughout so that the layer has a desired sheet resistance value. In place of the P-type well layer 143 to be the channel layer, a P-type diffused layer formed in the same process as the P-type diffused layer 102 to be the channel layer of the power MOS transistor 11 can be also used, however, the threshold voltage of the transistor for protection 14 can be set to a desired value by using the P-type well layer formed by another process.

As known referring to the circuit diagram shown in FIG. 1, when a transistor having trench structure is used for the transistor for protection 14, jumper wire for coupling the surface and the back of the substrate is required to couple the drain terminal of the transistor for protection 14 and the cathode terminal of the diode D1 because the drain electrode of the transistor for protection 14 is formed on the back of the substrate, whereby it is difficult to manufacture the device. However, by using the transistor of a horizontal type in this embodiment, the coupling of the drain terminal of the transistor for protection 14 and the cathode terminal of the diode D1 is facilitated. As described above, the number of processes to be added is minimized and the rise of the cost can be reduced by simultaneously forming the semiconductor regions and the electrodes of the transistor of a horizontal type, the resistors and the diode utilizing a process for forming the semiconductor region and the electrodes configuring the power MOS transistor having trench structure shown in FIG. 4.

The invention made by these inventors has been described concretely based upon the embodiment, however, it need scarcely be said that the invention is not limited to the embodiment and can be variously changed in a range which does not deviate from the summary. For example, in the above-mentioned embodiment, the diode D1 and the resistors RG1, RG2, RS1 are configured in a chip, however, devices may be also built in as all or a part of these devices.

The power IC for using the invention made by these inventors for a switch for turning on or off electrical equipment of an automobile which is a field of the application of the invention has been described above, however, the invention can be also widely utilized for a switching device for driving a coil of a switching regulator and a switching device for making current flow in a coil of a motor.

1. A power transistor device including
a power MOS transistor comprising a semiconductor region to be a source region and a source electrode formed on one main surface of a semiconductor substrate, further comprising a semiconductor region to be a drain region and a drain electrode formed on the other main surface of the semiconductor substrate and further comprising a gate electrode formed by conductive material filled in a groove formed on the semiconductor substrate so that drain current flows in a direction of the thickness of the substrate;
a current detecting circuit, formed on the semiconductor substrate, for detecting current flowing into the power MOS transistor and outputting the result of detection to an external device; and
a protection circuit, formed on the semiconductor substrate, for reducing current flowing into the power MOS transistor when the current flowing into the power MOS transistor is detected and is equal to or exceeds a predetermined value.

2. A power transistor device according to claim 1,
wherein the source region is formed on one main surface of the semiconductor substrate as plural semiconductor regions separated by the gate electrode, and the source electrode is formed by a continuous conductive layer touched to the plural semiconductor regions.

3. A power transistor device according to claim 2,
wherein the gate electrode is formed in a state in which each of plural semiconductor regions to be the source region is held between the gate electrodes or is surrounded by the gate electrodes, and an interval between the gate electrodes opposite with the source region is set to 5 μm or less.

4. A power transistor device according to claim 1,
wherein the current detecting circuit is provided with a transistor for detecting current in which a source region thereof is smaller than the source region of the power MOS transistor, and a voltage which is the same as the voltage applied to the gate electrode of the power MOS transistor is applied to the gate electrode, to make flow a current acquired by reducing the current flowing in the power MOS transistor in proportion, and
wherein in the transistor for detecting current, a semiconductor region to be a source region and a source electrode are formed on one main surface of the semiconductor substrate, a semiconductor region to be a drain region and a drain electrode are formed on the other main surface, a gate electrode formed by conductive material filled in a groove made on the semiconductor substrate is provided, and drain current is made to flow in a direction of the thickness of the substrate.

5. A power transistor device according to claim 4, comprising:
an external terminal coupled to the source region of the transistor for detecting current.

6. A power transistor device according to claim 1,
wherein the protection circuit comprises:
a second transistor for detecting current in which the source region thereof is smaller than the source region of the power MOS transistor, and the voltage which is the same as the voltage applied to the gate electrode of the power MOS transistor is applied to the gate electrode, to make flow the current acquired by reducing current flowing in the power MOS transistor in proportion;
a resistive element for converting current flowing in the second transistor for detecting current into a voltage; and
a MOS transistor in which the voltage converted by the resistive element is applied to the gate electrode and a drain electrode is coupled to the gate electrode of the power MOS transistor directly or via a second resistive element, and
wherein in the second transistor for detecting current, a semiconductor region to be a source region and a source electrode are formed on one main surface of the semiconductor substrate, a semiconductor region to be a drain region and a drain electrode are formed on the other main surface, a gate electrode formed by conductive material filled in a groove made on the semiconductor substrate is provided, and drain current flows in a direction of the thickness of the substrate.

7. A power transistor device according to claim 6,
wherein the MOS transistor is a MOS transistor of a horizontal type in which a semiconductor region to be a source region and a semiconductor region to be a drain region are formed on one main surface of the semiconductor substrate and drain current horizontally flows.

8. A power transistor device according to claim 7,
wherein a gate electrode of the MOS transistor is formed by a polysilicon layer, and the resistive element is configured by a polysilicon layer formed in the same process as the gate electrode of the MOS transistor.

9. A power transistor device according to claim 6,
wherein a rectifying device for preventing current from flowing in a reverse direction is provided between a drain electrode of the MOS transistor and the gate electrode of the power MOS transistor.

10. A power transistor device according to claim 9,
wherein the gate electrode of the MOS transistor is formed by a polysilicon layer, and the rectifying device is configured by a PN junction formed so that a region into which impurities to be an acceptor are doped and a region into which impurities to be a donor are doped are in contact in a polysilicon layer formed in the same process as the gate electrode of the MOS transistor.

11. A power control system, comprising:
a power transistor device including, on one semiconductor substrate,
a power MOS transistor in which a semiconductor region to be a source region and a source electrode are formed on one main surface of the semiconductor substrate, a semiconductor region to be a drain region and a drain electrode are formed on the other main surface, and a gate electrode formed by conductive material filled in a groove made on the semiconductor substrate is provided and drain current flows in a direction of the thickness of the substrate,
a current detecting circuit for detecting current flowing into the power MOS transistor and outputting the result of detection to an external device, and
a protection circuit for detecting current flowing into the power MOS transistor and reducing current flowing in the power MOS transistor in case the current is equal to or exceeds a predetermined value; and
a semiconductor integrated circuit device for control for generating gate control voltage on the power MOS transistor according to the result of the detection output from the current detecting circuit and supplying the gate control voltage to the power transistor device.

12. A power control system according to claim 11,
wherein the current detecting circuit includes a transistor for detecting current to which the same voltage as voltage applied to a gate electrode of the power MOS transistor is applied and through which current acquired by reducing current flowing in the power MOS transistor in proportion is made to flow,
wherein the power transistor device includes a first external terminal for outputting current flowing in the power MOS transistor and a second external terminal coupled to a source region of the transistor for detecting current,
wherein a load is coupled to the first external terminal,
wherein a resistive element for converting current into voltage is coupled to the second external terminal, and
wherein voltage converted by the resistive element is input to the semiconductor integrated circuit device for control.

13. A power control system according to claim 12,
wherein the power transistor device includes a third external terminal for transmitting the source electric potential of the power MOS transistor,
wherein the resistive element for converting current to voltage is coupled between the second external terminal and the third external terminal, and
wherein the electric potential at both terminals of the resistive element is input to the semiconductor integrated circuit device for control, the semiconductor integrated circuit device for control determines whether overcurrent flows or not based upon the electric potential at both terminals of the resistive element, and the gate control voltage is varied so as to turn off the power MOS transistor when the semiconductor integrated circuit for control determines that the overcurrent flows.

14. A power control system according to claim 11,
wherein the electric potential of the first external terminal is input to the semiconductor integrated circuit device for control, and the semiconductor integrated circuit device for control generates the gate control voltage based upon the electric potential of the first external terminal and
controls the current of the power MOS transistor.
